(19) United States
(12) Patent Application Publication
(10) Pub. No.: US 2002/0186873 A1
(43) Pub. Date: Dec. 12, 2002

(54) Image reproduction system

(75) Inventor: Ryoji Sasada, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/163,349

(22) Filed: Jun. 7, 2002

(30) Foreign Application Priority Data
Jun. 8, 2001 (JP) 173740/2001

(51) Int. Cl. G06K 9/40

(52) U.S. Cl. 382/132; 382/254; 382/298

(57) ABSTRACT

An image reproduction system includes an image output system which outputs a reproduced image on the basis of an original image data representing an image read out from an original. An image data server stores the original image data. The image output system includes an image display system which causes an image display section to reproduce as display an image on the basis of display image data obtained by causing a noise removing section to remove noise of a predetermined periodic pattern from the original image data read out from the image data server and causing an image processing section to carry out an enlargement/reduction processing on the processed original image data and an image recording system which reproduces as a hard copy recorded on a predetermined recording medium an image on the basis of the original image data read out from the image data server.

### BACKGROUND OF THE INVENTION

1. Field of the Invention

This invention relates to an image reproduction system which outputs a reproduction image on the basis of original image data obtained by reading out an original image recorded on a recording medium (photographic film, paper or the like)

2. Description of the Related Art

There has been put into practice in various fields an image reproduction system which outputs a reproduction image through a printer or the like on the basis of original image data obtained by reading out an original image recorded on a recording medium (photographic film, paper or the like) by the use of an image scanner or the like.

When certain kinds of phosphor are exposed to a radiation (x-rays, α-rays, β-rays, electron beams, ultraviolet rays), they store a part of energy of the radiation. Then when the phosphor which has been exposed to the radiation is exposed to stimulating rays such as visible light, light is emitted from the phosphor in proportion to the stored energy of the radiation. A phosphor exhibiting such properties is generally referred to as “a stimulable phosphor”. In this specification, the light emitted from the stimulable phosphor upon stimulation thereof will be referred to as “stimulated emission”. In the medical field, there has been known a radiation image recording/reproducing system in which a stimulable phosphor sheet (a sheet provided with a layer of the stimulable phosphor) is exposed to a radiation passing through an object such as a human body to have a radiation image of the object stored on the stimulable phosphor sheet, stimulating light beam such as a laser beam is caused to scan the stimulable phosphor sheet bearing thereon the radiation image of the object, the stimulated emission emitted from the stimulable phosphor sheet upon exposure to the stimulating light is photoelectrically detected, thereby obtaining a radiation image signal, and then a radiation image of the object is reproduced on the basis of the radiation image signal as a visible image on a recording medium such as a photographic film or a display such as a CRT. See, for instance, Japanese Unexamined Patent Publication Nos. 55(1980)-12429, 56(1981)-11396, 55(1980)-163472, 56(1981)-164645 and 55(1980)-116340.

When recording a radiation image of an object on a recording medium such as the stimulable phosphor sheet, a grid in which linear members of a radiation-untransmissible material (a material which is very low in permeability to the radiation) such as lead and linear members of a radiation-transmissible material (a material which is high in permeability to the radiation) such as aluminum or wood are alternately arranged at fine pitches of about 4/mm is sometimes interposed between the object and the stimulable phosphor sheet in order to prevent the stimulable phosphor sheet from being exposed to the radiation scattered by the object. By the use of such a grid, exposure of the stimulable phosphor sheet to the radiation scattered by the object is suppressed and the contrast of the radiation image of the object is enhanced. However, when a radiation image including therein an image of the grid is enlarged or reduced, aliasing is caused due to fold according to the rate of enlargement or reduction. Further, if the aliasing is superposed on the spatial frequency of, for instance, a grid image, fine moiré fringes are generated, which deteriorates quality of the reproduced image.

In view of these conditions, this applicant has proposed image signal generating methods of obtaining an image signal, on the basis of which an image having less moiré fringes and less aliasing can be reproduced, by carrying out on the image signal a filtering processing for removing spatial frequency components of the grid image and by removing high-frequency components of the grid image, which also causes moiré fringes and/or aliasing, as disclosed in a Japanese Unexamined Patent Publication No. 3(1991)-114039 and Japanese Patent Application 2000-257668.

However, if the spatial frequency components of the grid image are removed from the image signal by a filtering processing, there is a fear that high-frequency components useful for diagnosis are removed from the image signal together with the spatial frequency components of the grid image.

When an image is reproduced on the basis of the image signal removed with the high-frequency components together with the spatial frequency components of the grid image, lack of the high-frequency components is less remarkable when the image is displayed by a monitor or the like due to a low resolution and a narrow dynamic range, but lack of the high-frequency components deteriorates sharpness of fine structures such as micro calcification, bones, fine blood vessels and the like when the image is recorded on a recording medium such as a photographic film to be subjected to fine reading, which can involve a problem.

Further, as described above, the moiré fringes and the aliasing are generated when an image including a grid image is enlarged or reduced. In the case where a reproduced image is displayed on a monitor or the like and the reproduced image can be freely enlarged or reduced in real time, moiré fringes due to the grid image are more apt to be generated (there is a strong probability that a rate of enlargement or reduction at which the moiré fringes are apt to be generated is selected). To the contrast, in the case where the reproduced image is recorded on a recording medium such as a photographic film, it is difficult to freely enlarge or reduce the reproduced image, and accordingly, the reproduced image is generally output without enlargement or reduction or enlarged or reduced at a preset rate at which the moiré fringes are less apt to be generated.

### SUMMARY OF THE INVENTION

In view of the foregoing observations and description, the primary object of the present invention is to provide an image reproduction system which can output either an image signal on the basis of which an image display device such as a monitor can display an image free from moiré fringes or aliasing or an image signal in which high-frequency components useful for diagnosis are kept as they are.

In accordance with the present invention, there is provided an image reproduction system comprising an image output means which outputs a reproduced image on the basis of an original image data representing an image read out from an original, wherein the improvement comprises that

an image storage means which stores the original image data is provided, and

the image output means comprises

an image display means which causes an image display section to reproduce as display an image on the basis of display image data obtained by causing a noise removing section to remove noise of a predetermined periodic pattern, if any, from the original image data read out from the image storage means and causing an image processing section to carry out an enlargement/reduction processing on the processed original image data (resultant image data), and

an image recording means which reproduces as a hard copy recorded on a predetermined recording medium an image on the basis of the original image data read out from the image storage means.

The original image data need not always has noise of the predetermined periodic pattern, and the noise removing section may remove noise of the predetermined periodic pattern only when the original image data includes therein noise of the predetermined periodic pattern.

The “noise of the predetermined periodic pattern” may be, for instance, image data components representing a grid image which are included in the original image data when a radiation image is taken by the use of said grid.

The image processing section may carry out the enlargement/reduction processing at a plurality of predetermined rates of enlargement or reduction, and the image display means may cause the image display section to reproduce an image on the basis of at least one pieces of display image data obtained by enlarging or reducing the processed original image data, removed with the aforesaid noise, at said plurality of predetermined rates of enlargement or reduction.

An input means through which one or more rates of enlargement or reduction other than the predetermined rates of enlargement or reduction can be input may be provided.

The input means may be a means through which one or more rates of enlargement or reduction can be directly input or a means which reads a rate of enlargement or reduction attached to the original image data or the processed original image data and inputs the rate.

The processed original image data may be lower than the original image data in resolution.

The term “resolution” as used here means the pixel density of an image on the basis of image data.

The original image data as input into the image output means may be attached with attendant information and the noise removing section may remove the noise of the predetermined periodic pattern from the original image data on the basis of the attendant information.

The attendant information may include one of information representing at least one of image processing parameters to be used in the noise removing section, information representing the resolution of the original image data and information representing the noise of the periodic pattern included in the original image data.

The “image processing parameters to be used in the noise removing section” means, for instance, information on a filter to be used in an image processing to be carried out on the original image data to remove the grid image, the “information representing the resolution of the original image data” means, for instance, the density at which the original image has been read out by an image read-out means, and the “information representing the noise of the periodic pattern included in the original image data” means, for instance, information on whether the original image data includes a grid image, the direction of the grid or the period thereof.

The original image may be a radiation image.

In the image reproduction system of the present invention, an image is reproduced on the basis of display image data obtained by removing noise of a predetermined periodic pattern from the original image data read out from the image storage means and carrying out an enlargement/reduction processing on the resultant image data when the image is to be reproduced as display and on the basis of the original image data as read out from the image storage means when the image is to be reproduced as a hard copy.

Accordingly, an image can be reproduced either as display which is in a desired scale and is free from moiré fringes or aliasing or a hard copy which is free from moiré fringes or aliasing and at the same time, holds high-frequency components useful for diagnosis as they are.

When the image processing section is able to carry out the enlargement/reduction processing at a plurality of predetermined rates of enlargement or reduction, and the image display means causes the image display section to reproduce an image on the basis of at least one pieces of display image data obtained by enlarging or reducing the processed original image data at said plurality of predetermined rates of enlargement or reduction, a plurality of images at different rates of enlargement or reduction can be reproduced at one time.

When an input means through which one or more rates of enlargement or reduction other than the predetermined rates of enlargement or reduction can be input is provided, the reproduced image can be in a desired scale other than the preset scales.

Further, when the processed original image data may be lower than the original image data in resolution, the enlargement/reduction processing can be performed at high speed.

Further, when the original image data as input into the image output means is attached with attendant information and the noise removing section removes the noise of the predetermined periodic pattern from the original image data on the basis of the attendant information, a noise removing processing can be performed properly according to the type of the original image data.

### BRIEF DESCRIPTION OF THE DRAWINGS

FIG. 1 is a block diagram showing a radiation image reproducing system in accordance with an embodiment of the present invention,

FIG. 2 is a schematic view showing an example of a radiation image taking apparatus,

FIG. 3 is a view showing an example of a radiation image taken by the use of a grid,

FIG. 4 is a perspective view showing an example of a radiation image read-out means, and

FIG. 5 is a block diagram showing the image display means.

### DESCRIPTION OF THE PREFERRED EMBODIMENT

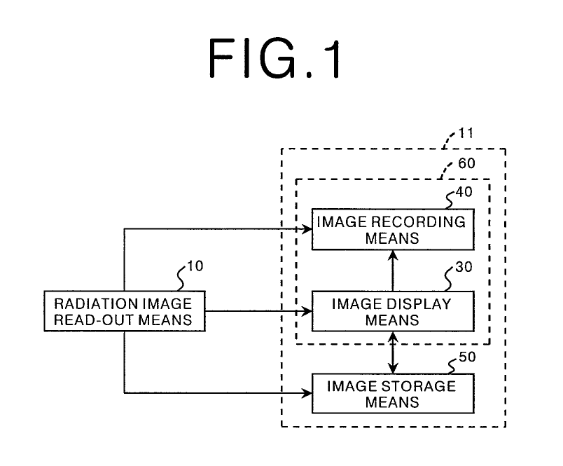

A radiation image reproducing system in accordance with an embodiment of the present invention will be described with reference to FIG. 1, hereinbelow.

In FIG. 1, the radiation image reproducing system 11 of this embodiment comprises an image output means 60, which comprises an image display means 30 for carrying out a grid removing processing on original image data read out by a radiation image read-out means 10 to remove a grid image therefrom, carrying out an enlargement/reduction processing on the resultant image data, thereby generating display image data, and reproducing an image as display on a screen on the basis of the display image data and an image recording means 40 for reproducing as a hard copy on a predetermined recording medium such as a photographic film on the basis of the original image data read out by a radiation image read-out means 10, and an image storage means 50 which stores the original image data read out by the radiation image read-out means 10.

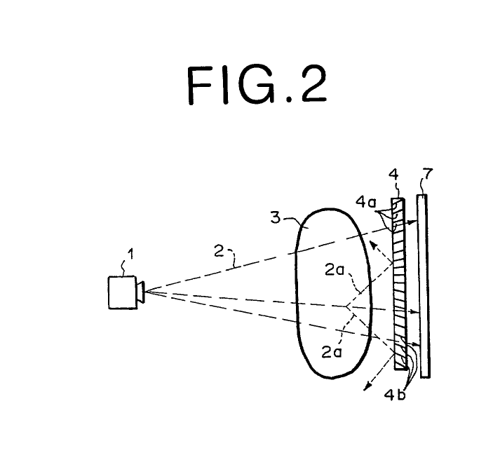

In this particular embodiment, the radiation image read-out means 10 reads out a radiation image recorded on a stimulable phosphor sheet 7 (FIG. 2) in the following manner.

A radiation 2 radiated from a radiation source 1 is projected onto a stimulable phosphor sheet 7 through an object 3 and a stationary grid 4. The stationary grid 4 comprises linear lead members 4a and linear aluminum members which are alternately arranged at pitches of 4/mm. The radiation 2 is cut by the lead members 4a and passes through the aluminum members 4b to be projected onto the stimulable phosphor sheet 7. Accordingly, an image of the grid 4 is recorded on the stimulable phosphor sheet 7 together with a radiation image of the object 3. Radiation 2a scattered in the object 3 obliquely impinges upon the grid 4 and accordingly is partly cut by the grid 4 and partly reflected by the grid 4, whereby the scattered radiation can hardly impinge upon the stimulable phosphor sheet 7 and a sharp radiation image is recorded on the stimulable phosphor sheet 7. The spatial frequency of the grid image is 4 cycles/mm.

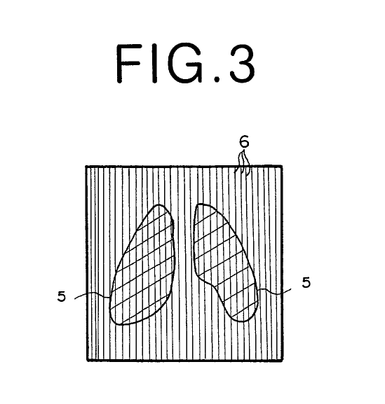

FIG. 3 shows a radiation image recorded on the stimulable phosphor sheet 7 by the use of the grid 4, where an image 6 of the grid 4 (marked by the vertical stripes) is superposed on a radiation image 5 of the object 3 (marked by the oblique stripes).

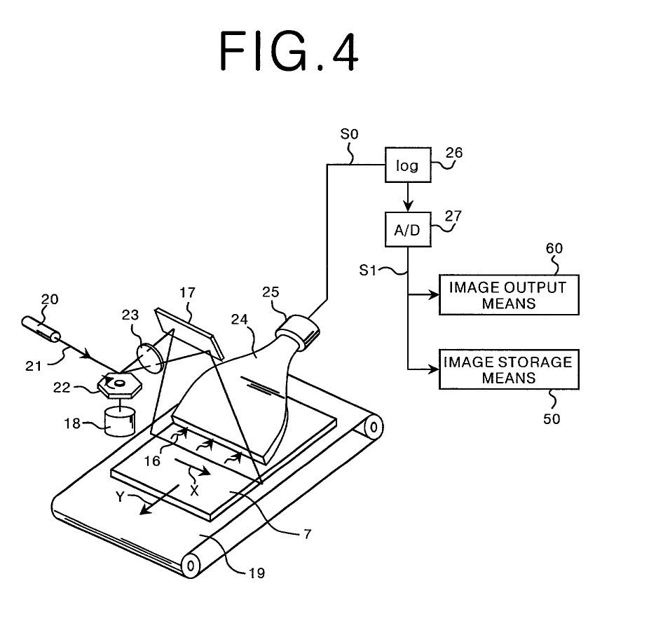

The radiation image read-out means 10 will be described with reference to FIG. 4, hereinbelow.

The stimulable phosphor sheet 7 which has been exposed to the radiation 2 through the object 3 is conveyed by a sheet conveyor means 19 (which may be an endless belt) driven by a driving means (not shown) in the direction arrow Y (sub-scanning). The stimulable phosphor sheet 7 is set on the sheet conveyor means 19 so that the stimulable phosphor sheet 7 is conveyed in perpendicular to the grid image 6. While the stimulable phosphor sheet 7 is being conveyed by the sheet conveyor means 19 in the direction of arrow Y, a laser beam 21 emitted from a laser 20 is caused to scan the stimulable phosphor sheet 7 in a main scanning direction (the direction of arrow X) substantially perpendicular to the sub-scanning direction by a scanning optical system comprising a rotary polygonal mirror 22 driven by a motor 18 to rotate at high speed in the direction of the arrow, a condenser lens 23 (which may be an fθ lens) and a mirror 17. In this particular embodiment, the read-out density of the radiation image read-out means 10 in the main scanning direction can be switched between 10 pixels/mm and 5 pixels/mm. Since the stationary grid is generally 3.4/mm, 4/mm, 6/mm or 8/mm in density (3.4 cycles/mm, 4 cycles/mm, 6 cycles/mm or 8 cycles/mm in spatial frequency), the Nyquist frequency is 2.5 cycles/mm. Accordingly, no grid image exists in original image data when the read-out density of the radiation image read-out means 10 is 5 pixels/mm. To the contrast, when the read-out density of the radiation image read-out means 10 is 10 pixels/mm, there exists a grid image in the original image data, and accordingly, it is necessary to carry out a grid removing processing in a grid removing section 31 (to be described later) of the image display means 30. The parts of the stimulable phosphor sheet 7 exposed to the laser beam 21 emits stimulated emission 16 in amounts proportional to the amounts of radiation energy stored therein. The stimulated emission 16 is led to a photomultiplier 25 by a light guide 24 and is photoelectrically detected by the photomultiplier 25, whereby the amounts of the stimulated emission 16 representing a radiation image of the object 3 are converted into an analog electric image signal S0.

The analog image signal S0 is logarithmically amplified by a logarithmic amplifier 26 and then sampled at 10 pixels/mm by an A/D convertor 27 to be digitized into a digital original image data S1. The original image data S1 is input into the image output means 60 and the image storage means 50 together with information on the read-out density as attendant information.

The image storage means 50 in this particular embodiment is an image data server which stores the original image data read out by the radiation image read-out means 10. When the original image data is attached with attendant information such as on the read-out density output from the radiation image read-out means 10, the image storage means 50 stores the original image data together with the attendant information. The image storage means 50 may be arranged to store processed image data obtained by removing noise from the original image data in the image display means 30.

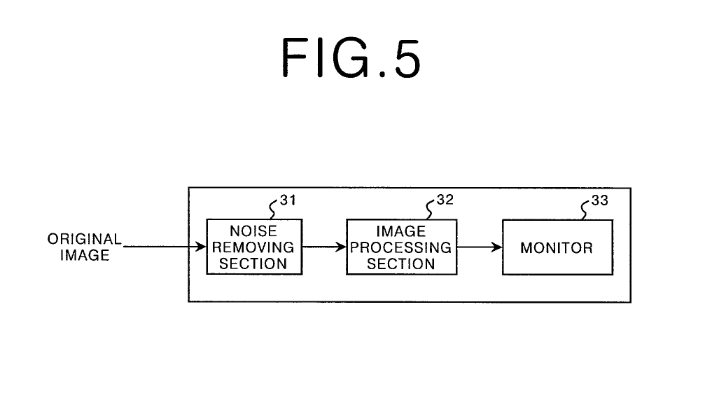

As shown in FIG. 5, the image display means 30 comprises a noise removing section 31 which carries out a noise removing processing on the original image data output from the radiation image read-out means 10, an image processing section 32 which carries out an enlargement processing or a reduction processing on the processed image data (removed with noise) output from the noise removing section 31, thereby obtaining display image data, and a monitor 33 which reproduces an image as display on the basis of the display image data.

Though being mainly for displaying on the monitor 33 an image reproduced on the basis of the display image data obtained by enlarging or reducing the original image data, the image display means 30 may display an image reproduced on the basis of the original image data or the processed image data (removed with noise) stored in the image storage means 50 or the original image data as output from the radiation image read-out means 10.

The image recording means 40 comprises a printer (not shown) which records an image reproduced on the basis of the original image data output from the radiation image read-out means 10 on a recording medium such as a photographic film. Though being mainly for recording an image reproduced on the basis of the original image data output from the radiation image read-out means 10, the image recording means 40 may record an image reproduced on the basis of the processed image data or the display image data.

The operation of the radiation image reproducing system of this embodiment will be described, hereinbelow.

The original image data representing a radiation image recorded on the stimulable phosphor sheet 7 is read out by the radiation image read-out means 10 in the manner described above and input into the image output means 60. At this time, whether an image is to be reproduced by the image display means 30 as display on the basis of display image data created on the basis of the original image data or to be reproduced as a hard copy by the image recording means 40 is selected through an input means (not shown).

When that an image is to be reproduced by the image display means 30 as display on the basis of the display image data is selected, the original image data is input into the noise removing section 31 of the image display means 30. At this time, the attendant information on the read-out density is input into the image display means 30 together with the original image data. The noise removing section 31 of the image display means 30 carries out the noise removing processing on the original image data when the read-out density of the radiation image read-out means 10 is 10 pixels/mm and outputs the original image data removed with the noise to the image processing section 32 as the processed original image data. Whereas, when the read-out density of the radiation image read-out means 10 is 5 pixels/mm, the noise removing section 31 outputs the original image data to the image processing section 32 as the processed original image data without carrying out the noise removing processing. The image processing section 32 carries out an enlargement processing or a reduction processing at a predetermined rate of enlargement or reduction and outputs the resultant image data to the monitor 33 as display image data. A plurality of rates of enlargement or reduction may be set in advance in the image processing section 32 so that the image processing section 32 creates a plurality of pieces of display image data obtained by enlarging or reducing the original image data at the rates of enlargement or reduction set in advance and a plurality of images are reproduced on the basis of plurality of pieces of display image data at one time on the monitor 33. One or more rates of enlargement or reduction other than the rates of enlargement or reduction set in advance in the image processing section 32 may be input into the image processing section 32 through an input means (not shown) or when the original image data or the processed original image data is provided with attendant information representing the rate of enlargement of reduction at which the radiation image is to be enlarged or reduced, the rate of enlargement of reduction represented by the attendant information may be input into the image processing section 32.

When that an image is to be reproduced by the image recording means 40 as a hard copy is selected, the original image data is input into the image recording means 40 directly from the radiation image read-out means 10 or by way of the image display means 30. The image recording means 40 prints by the printer an image reproduced on the basis of the original image data. The image thereby reproduced is an original image with the grid image.

The original image data read out by the radiation image read-out means 10 is input into the image storage means 50 directly from the radiation image read-out means 10 or by way of the image display means 30 together with the attendant information. The image storage means 50 stores the original image data in combination with the attendant information. The image storage means 50 may be arranged to store also the original image data removed with the noise (the processed original image data) output from the noise removing section 31 of the image display means 30. In this case, when the original image is read out by the radiation image read-out means 10 at 10 pixels/mm, original image data with a grid image and processed image data removed with a grid image are stored in the image storage means 50 and when the original image is read out by the radiation image read-out means 10 at 5 pixels/mm, original image data without a grid image is only stored in the image storage means 50.

The original image data and the processed original image data thus stored in the image storage means 50 can be output as a reproduced image at any time in response to a predetermined input signal from an input means (not shown).

Though, in the embodiment described above, the original image data representing an original image is obtained by reading out an image recorded on a recording medium (a stimulable phosphor sheet in the particular embodiment), the original image data may be obtained directly from a solid state radiation image sensor or the like.

The image reproduction system 11 of this embodiment is provided with the image display means 30 which reproduces an image as display on the basis of display image data obtained by removing the grid image from the original image data read out from the image storage means 50 and causing the image processing section 32 to carry out an enlargement/reduction processing on the resultant original image data removed with the grid image, and the image recording means 40 which reproduces as a hard copy recorded on a predetermined recording medium an image on the basis of the original image data read out from the image storage means 50. Accordingly, a reproduced image can be displayed at any time on the monitor 33 on the basis of the display image data which is enlarged or reduced and free from noise of a periodic pattern, and at the same time, an image based on the original image data holding the high-frequency components useful for diagnosis can be reproduced as a hard copy free from moiré fringes or aliasing.

It is preferred that the resolution of the processed original image data output from the noise removing section 31 of the image display means 30 be lower than the resolution of the original image data so that the enlargement processing or the reduction processing in the image processing section 32 can be performed at high speed. When an enhancement processing and/or a gradation processing is carried out in the image processing section 32 in addition to the enlargement/reduction processing, also the enhancement processing and the gradation processing can be carried out at high speed if the resolution of the processed original image data output from the noise removing section 31 of the image display means 30 is lower than the resolution of the original image data. The resolution of the processed original image data output from the noise removing section 31 of the image display means 30 may be set to be equal to that of the monitor 33.

It is possible to arrange the noise removing section 31 to automatically recognize the grid image included in the original image data and to perform the noise removing processing on the basis of the result of the recognition, or to perform the noise removing processing on the basis of the information on the grid image input through a predetermined input means or on the basis of information on the imaging menu. Further, the noise removing processing to be performed by the noise removing section 31 may be changed according to the orientation of the grid image and/or the frequency of the grid image.

Further, the grid removing processing may be changed by changing one or more image processing parameter according to the result of the aforesaid automatic recognition, the information on the grid image input through the input means and/or the information on the imaging menu.

Even if it is determined that the grid removing processing is unnecessary on the basis of the aforesaid automatic recognition, the information on the imaging menu, or the like, the grid removing processing may be carried out in response to instruction through a predetermined input means.

What is claimed is:

1. An image reproduction system comprising an image output means which outputs a reproduced image on the basis of an original image data representing an original image, wherein the improvement comprises that
an image storage means which stores the original image data is provided, and
the image output means comprises
an image display means which causes an image display section to reproduce as display an image on the basis of display image data obtained by causing a noise removing section to remove noise of a predetermined periodic pattern, if any, from the original image data read out from the image storage means and causing an image processing section to carry out an enlargement/reduction processing on the processed original image data, and
an image recording means which reproduces as a hard copy recorded on a predetermined recording medium an image on the basis of the original image data readout from the image storage means.

2. An image reproduction system as defined in claim 1 in which the image processing section can carry out the enlargement/reduction processing at a plurality of predetermined rates of enlargement or reduction, and the image display means causes the image display section to reproduce an image on the basis of at least one pieces of display image data obtained by enlarging or reducing the processed original image data at said plurality of predetermined rates of enlargement or reduction.

3. An image reproduction system as defined in claim 2 further comprising an input means through which one or more rates of enlargement or reduction other than the predetermined rates of enlargement or reduction can be input.

4. An image reproduction system as defined in claim 1 in which the processed original image data is lower than the original image data in resolution.

5. An image reproduction system as defined in claim 1 in which the original image data as input into the image output means is be attached with attendant information and the noise removing section removes the noise of the predetermined periodic pattern from the original image data on the basis of the attendant information.

6. An image reproduction system as defined in claim 1 in which the attendant information includes one of information representing at least one of image processing parameters to be used in the noise removing section, information representing the resolution of the original image data and information representing the noise of the periodic pattern included in the original image data.

7. An image reproduction system as defined in claim 1 in which the original image is a radiation image.

8. An image reproduction system as defined in claim 1 in which the noise of periodic pattern is an image of a stationary grid.
